(19) United States
(12) Patent Application Publication
(10) Pub. No.: US 2012/0096678 A1
(43) Pub. Date: Apr. 26, 2012

(54) HINGE MECHANISM

(75) Inventors: HAN-ZHENG ZHANG, Shenzhen City (CN); JIAN LI, Shenzhen City (CN); SHEN LI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/152,408

(22) Filed: Jun. 3, 2011

(30) Foreign Application Priority Data
Oct. 26, 2010 (CN) 201010520086.2

(51) Int. Cl. E05D 3/06

(52) U.S. Cl. 16/302

(57) ABSTRACT

A hinge mechanism includes two pivot shafts, two rotating shafts, a first connection member, a second connection member, two main gears, two transmission gears, and two resilient members. The two pivot shafts are substantially parallel to each other. The two rotating shafts are parallelly positioned between the two pivot shafts. The first connection member is sleeved on the two pivot shafts and the two rotating shafts together with the second connection member. The two main gears are sleeved on the two pivot shafts respectively. The two transmission gears are respectively sleeved on the two rotating shafts together with the two resilient members, and positioned between the two main gears. Each transmission gear engages with the other transmission gear and one of the main gears. The two main gears and the two transmission gears are held between the first and second connection members.

### BACKGROUND

1. Technical Field

The present disclosure generally relates to hinges, and more particularly to a hinge mechanism applied in an electronic device.

2. Description of Related Art

Many electronic devices, such as notebook computers, game players, electronic books, and mobile phones include hinged elements. To ensure the electronic device can be opened or closed smoothly and quickly by rotating one part of the electronic device relative to the other part thereof, a commonly used hinge mechanism applied in the electronic device includes four gears to transmit the torque.

However, the gears used in the hinge mechanism are easily worn out and damaged, thereby, reducing a transmission accuracy of the commonly used hinge mechanism.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 is an assembled, isometric view of one embodiment of a hinge mechanism.

FIG. 2 is an exploded, isometric view of the hinge mechanism of FIG. 1.

FIG. 3 is similar to FIG. 2, but viewed from another aspect.

FIG. 4 is a top view of the hinge mechanism of FIG. 1.

### DETAILED DESCRIPTION

The present embodiment of a hinge mechanism may be applied in an electronic device having two or more hinged parts, such as notebook computers, LCD monitors, or DVD players. In this embodiment, the hinge mechanism described and illustrated herein is applied in a notebook computer.

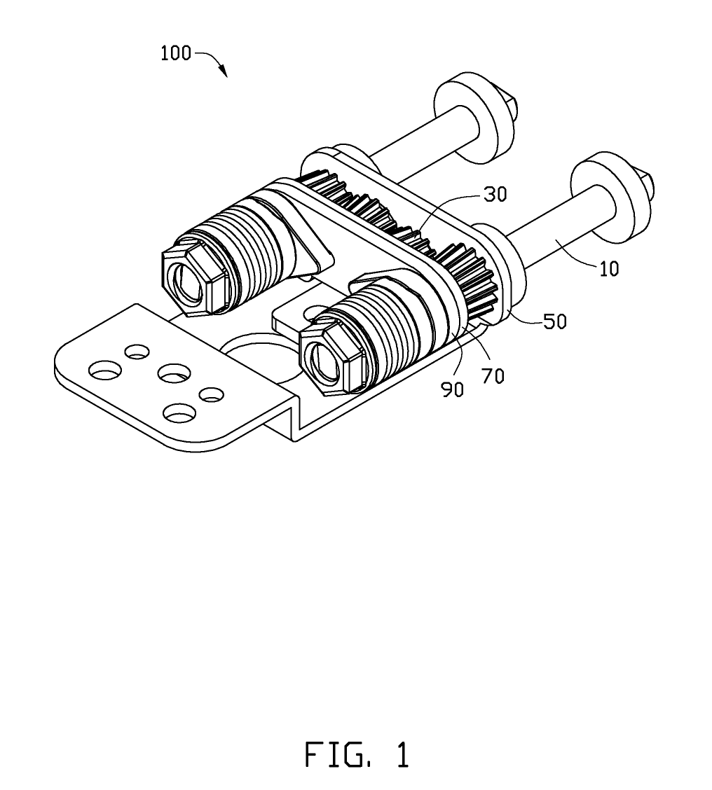

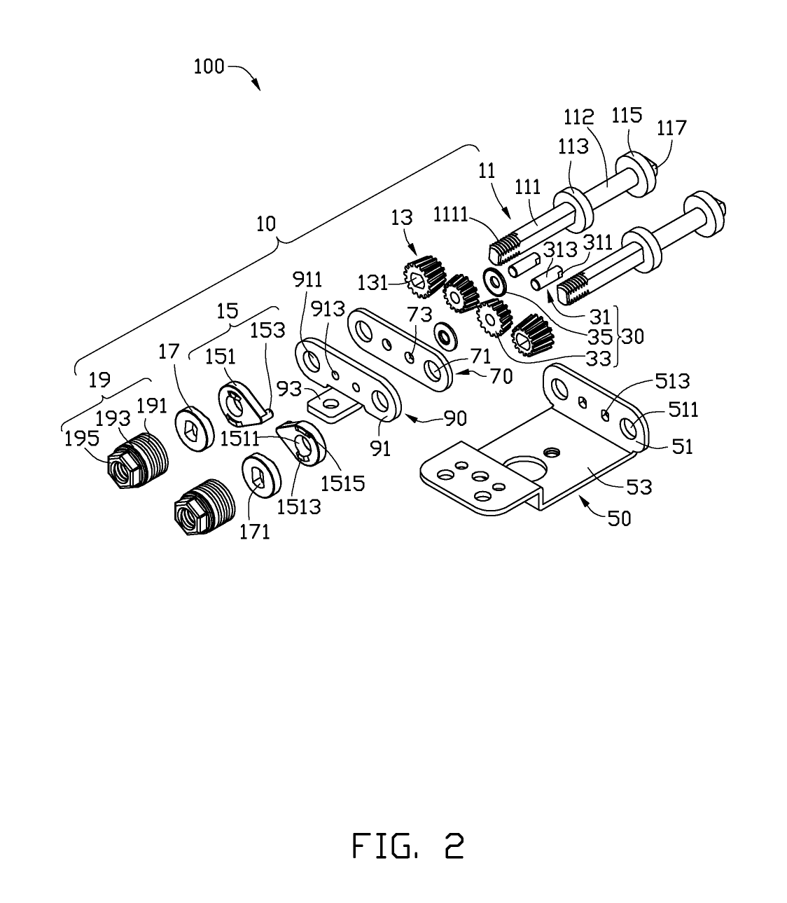

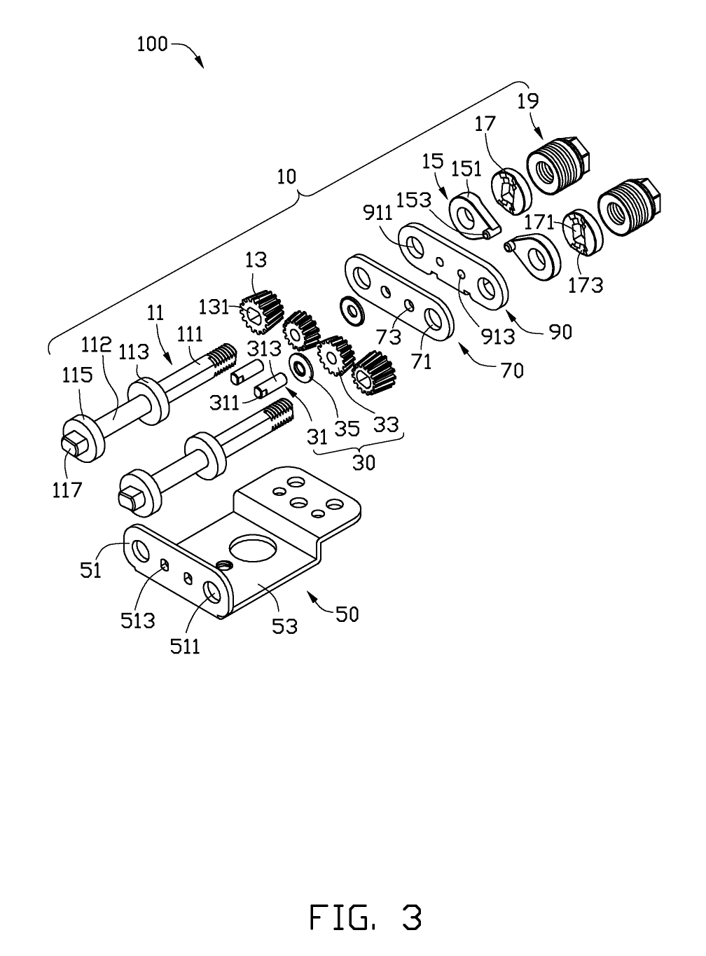

Referring to FIGS. 1 through 3, a hinge mechanism 100 includes two rotation assemblies 10, a transmission assembly 30, a first connection member 50, a second connection member 70, and a reinforcing member 90. The two rotation assemblies 10 are positioned parallel to each other, and are rotatably assembled together via the transmission assembly 30, the first and second connection members 50, 70, and the reinforcing member 90. The transmission assembly 30 is assembled between the two rotation assemblies 10 for transmitting a rotating torque between the two rotation assemblies 10. The first connection member 50, the second connection member 70, and the reinforcing member 90 are all sleeved on the two rotation assemblies 10, thereby rotatably assembling the two rotation assemblies 10 together.

Each rotation assembly 10 includes a pivot shaft 11, a main gear 13, a cam 15, a cam follower 17, and a fastening module 19 sleeved on the pivot shaft 11 in that order. In one embodiment, the main gear 13 is non-rotatably sleeved on the pivot shaft 11. The cam 15 is rotatably sleeved on the pivot shaft 11. The cam follower 17 is non-rotatably sleeved on the pivot shaft 11 and engages with the corresponding cam 15. The fastening module 19 is fixed to one distal end of the pivot shaft 11 for adjusting the tightness of the rotation assembly 10. Alternatively, the cam 15 may also configured to be non-rotatably sleeved on the pivot shaft 11, and accordingly, the cam follower 17 is configured to be rotatably sleeved on the pivot shaft 11 and rotatably engages with the corresponding cam 15.

The pivot shaft 11 includes a non-circular shaft portion 111, a circular shaft portion 112, a first flange 113, a second flange 115, and a non-circular connecting portion 117. The non-circular shaft portion 111 and the non-circular connecting portion 117 are coaxially connected to opposite ends of the circular shaft portion 112, respectively. The non-circular shaft portion 111 defines a threaded portion 1111 at a distal end thereof. The first flange 113 is formed at a joint of the non-circular shaft portion 111 and the circular shaft portion 112. The second flange 115 is formed at a joint of the non-circular connecting portion 117 and the circular shaft portion 112.

The main gear 13 defines a non-circular hole 131 therethrough. In the illustrated embodiment, the main gear 13 is a spur bevel gear. It is to be understood that the main gear 13 can also be a skew bevel gear.

The cam 15 includes a main body 151 and a latching portion 153 formed on one end surface (not labeled) of the main body 151, and the latching portion 153 is positioned adjacent to an edge of the end surface of the main body 151. A shaft hole 1511 is defined through the main body 151 and is positioned at the substantially central portion of the end surface of the main body 151. A first protrusion 1513 is formed on the other end surface (not labeled) of the main body 151 away from the latching portion 153 and is positioned adjacent to the shaft hole 1511. A second protrusion 1515 is formed on a same side or end surface of the main body 151 together with the first protrusion 1513, and is positioned adjacent to an edge of the main body 151.

The cam follower 17 rotatably engages with the cam 15, and is also sleeved on the non-circular shaft portion 111 of the pivot shaft 11 together with the cam 15. The cam follower 17 defines a non-circular sleeving hole 171 and further includes two cutouts 173 recessed in an end surface (not labeled) of the cam follower 17 corresponding to the first and second protrusions 1513, 1515 of the cam 15.

The fastening module 19 is securely sleeved on the pivot shaft 11, and includes an elastic member 191, a friction member 193 and a fastener 195. The friction member 193 is sandwiched or held between the elastic member 191 and the fastener 195. In one embodiment, the elastic member 191 includes two disc shaped elastic pieces. Alternatively, the elastic member 191 could also be a compression spring. The fastener 195 is a nut screwed on the threaded portion 1111 of the non-circular shaft portion 111 of the pivot shaft 11.

The transmission assembly 30 includes two rotating shafts 31, two transmission gears 33 and two resilient member 35. The two rotating shafts 31 are parallelly positioned. Each rotating shaft 31 includes a non-circular variant portion 311 and a circular connecting shaft portion 313. The two transmission gears 33 are respectively sleeved on the circular connecting shaft portions 313 of the two rotating shafts 31. Each transmission gear 33 has a thickness less than that of the corresponding main gear 13. In one embodiment, the transmission gear 33 is a spur bevel gear engaging with the corresponding one main gear 13. Alternatively, the transmission gear 33 can also be a skew bevel gear. Preferably, the thickness of the transmission gear 33 is half of the thickness of the main gear 13. The resilient member 35 is substantially disc shaped, and is sleeved on the rotating shaft 31 for elastically resisting on the larger end of the transmission gear 33. Alternatively, the resilient member 35 could also be a compression spring.

The first connection member 50 is a plate, which includes a resisting portion 51 and a fixing portion 53 extending from a side edge of the resisting portion 51. In the illustrated embodiment, the fixing portion 53 is substantially perpendicular to the resisting portion 51, for connecting to a connecting arm positioned in between, and connecting with a cover and a main body of an electronic device (not shown). Two pivotal holes 511 are respectively defined through the resisting portion 51 and positioned adjacent to two ends of the resisting portion 51 corresponding to the two pivot shafts 11. Two non-circular rotating shaft holes 513 are separately defined through the resisting portion 51 and positioned between the two pivotal holes 511, which are corresponding to the two rotating shafts 31.

The second connection member 70 is a substantially rod-shaped plate, and defines two pivotal holes 71 and two rotating shaft holes 73 corresponding to the two pivotal holes 511 and the two rotating shaft holes 513 of the resisting portion 51, respectively.

The reinforcing member 90 includes a resisting plate 91 and a fixing protrusion 93 extending substantially perpendicularly from one edge of the resisting plate 91. The resisting plate 91 has substantially the same shape and structure as that of the second connection member 70. The resisting plate 91 defines two sleeving holes 911 corresponding to the two pivotal holes 71 of the second connection member 70, and further defines two limit holes 913 positioned between the two sleeving holes 911.

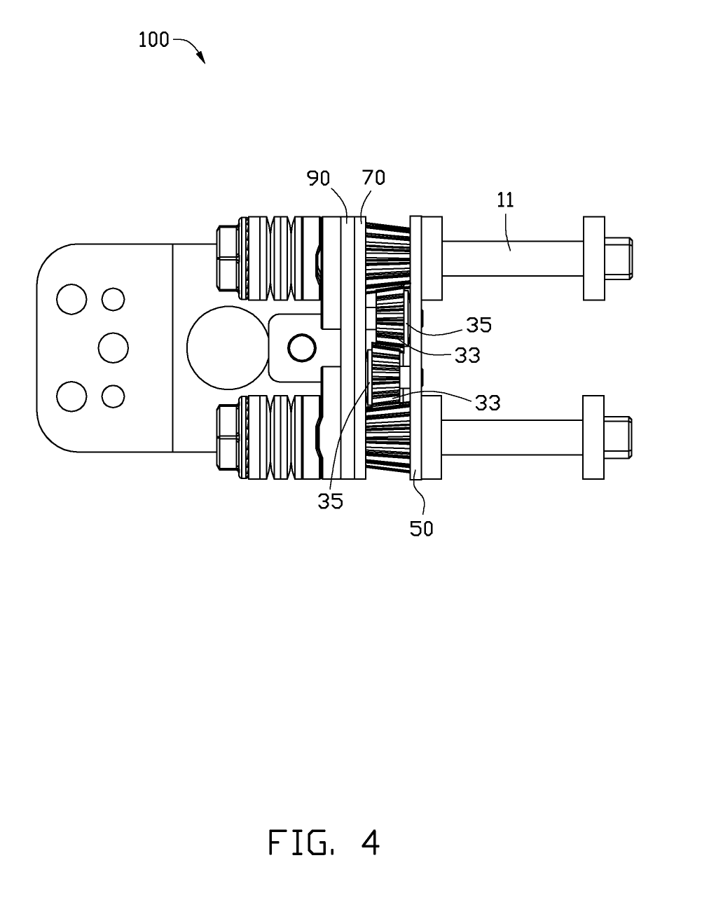

Also referring to FIG. 4, during assembly of the hinge mechanism 100, the two rotating shafts 31 are parallelly assembled to the first connection member 50, the two non-circular variant portions 311 of the two rotating shafts 31 are respectively inserted into and fixed to the two non-circular rotating shaft holes 513 of the resisting portion 51 of the first connection member 50. The two transmission gears 33 are respectively parallelly sleeved on the two connecting shaft portions 313 of the two rotating shafts 31 together with the corresponding two resilient members 35, and engaged with each other. The two non-circular shaft portions 111 of the two pivot shafts 11 respectively pass through the two pivotal holes 511 of the resisting portion 51 of the first connection member 50, and are positioned upon the fixing portion 53. The two first flanges 113 of the two pivot shafts 11 respectively resist and contact with one surface of the resisting portion 51 away from the fixing portion 53. The two main gears 13 are respectively non-rotatably sleeved on the two non-circular shaft portions 111 of the two pivot shafts 11, and engaged with the corresponding two transmission gears 33 respectively. The second connection member 70 is sleeved on the two non-circular shaft portions 111 of the two pivot shafts 11 together with the reinforcing member 90 in that order. The distal ends of the two connecting shaft portions 313 of the two rotating shafts 31 pass through and are assembled to the two rotating shaft holes 73 of the second connection member 70. Such that, the two main gears 13 and the two transmission gears 33 are sandwiched or held between the resisting portion 51 of the first connection member 50 and the second connection member 70. The two resilient members 35 elastically resist against the larger end of the corresponding two transmission gears 33, respectively.

The two cams 15 are respectively rotatably sleeved on the two non-circular shaft portions 111 of the two pivot shafts 11, and contacted with the reinforcing member 90. The latching portion 153 of each cam 15 is latched into the corresponding limit hole 913 of the reinforcing member 90. The two cam followers 17 are respectively non-rotatably sleeved on the two non-circular shaft portions 111 of the two pivot shafts 11, and respectively engage with the corresponding two cams 15. Finally, the two fastening modules 19 are respectively screwed on the two threaded portions 1111 of the two non-circular shaft portions 111 of the two pivot shafts 11 to finish the assembly of the hinge mechanism 100.

When the hinge mechanism 100 is applied to an electronic device in use, an external force is exerted on a first part (e.g. a cover) of the electronic device for driving a rotation assembly 10 to rotate with the first part of the electronic device. The transmission assembly 30 transmits the torque to the main gear 13 of the other rotation assembly 10, thus the main gear 13 of the second part (e.g. a main body) is driven to rotate in an opposite direction to the main gear 13 of the one rotation assembly 10. The other rotation assembly 10 transmits the torque to the other part (not labeled) of the electronic device by the pivot shaft 11. Therefore, the two parts of the electronic device may be opened or closed quickly. As the resilient member 35 elastically resists against the larger end of the corresponding transmission gear 33, abrasion is created between the transmission gear 33 and the main gear 13, and the resilient member 35 would push the transmission gear 33 to move axially toward the corresponding main gear 13, thereby keeping the main gear 13 and the transmission gear 33 stably engaging with each other. Thus, the hinge mechanism 100 has a higher transmission accuracy in additional to a more stable transmission.

It is to be understood that the reinforcing member 90 may also be omitted, such that, the latching portion 153 of the cam 15 is latched with the corresponding rotating shaft hole 73 of the second connection member 70.

It is to be understood, however, that even through numerous characteristics and advantages of the disclosure have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A hinge mechanism, comprising:
two pivot shafts substantially parallel to each other;
two rotating shafts positioned between the two pivot shafts and being parallel to each other;
a first connection member sleeved on the two pivot shafts and the two rotating shafts;
two main gears non-rotatably sleeved on the two pivot shafts, respectively; the two main gears being bevel gears;
two transmission gears rotatably sleeved on the two rotating shafts, respectively, the two transmission gears being bevel gears, and positioned between the two main gears, and each transmission gear engaging with the other transmission gear and one of the main gears;
a second connection member sleeved on the two pivot shafts and the two rotating shafts, thereby holding the two main gears and the two transmission gears between the first and second connection members; and
two resilient members sleeved on the two rotating shafts, respectively, and each resilient member elastically resisting on a larger end of one corresponding transmission gear axially.

2. The hinge mechanism of claim 1, wherein the main gears and the transmission gears are both spur bevel gears or skew bevel gears.

3. The hinge mechanism of claim 1, wherein the transmission gear has a thickness less than that of the corresponding main gear.

4. The hinge mechanism of claim 3, wherein the transmission gear has a thickness to be half of the thickness of the corresponding main gear.

5. The hinge mechanism of claim 1, wherein the hinge mechanism further comprises a reinforcing member sleeved on the two pivot shafts and resisted against the second connection member.

6. The hinge mechanism of claim 5, wherein the hinge mechanism further comprises two cams and two cam followers, the two cams are respectively rotatably sleeved on the pivot shaft and resisted against the reinforcing member; the two cam followers are non-rotatably sleeved on the two pivot shafts and each cam follower engages with one corresponding cam.

7. The hinge mechanism of claim 6, wherein the reinforcing member defines two limit holes; the cam comprises a main body and a latching portion formed on the main body, the main body defines a shaft hole, the main body is sleeved on one pivot shaft via the shaft hole; the latching portion of each cam is latched into one limit hole of the reinforcing member.

8. The hinge mechanism of claim 7, wherein the cam further comprises two protrusions formed on one end surface of the main body thereof away from the side of the latching portion; the cam follower rotatably engages with the cam, and defines two cutouts engaging with the corresponding two protrusions of the cam.

9. The hinge mechanism of claim 6, further comprising two fastening modules respectively fixed to the two pivot shafts and resisting against the two corresponding two cam followers.

10. The hinge mechanism of claim 9, wherein each fastening module comprises an elastic member, a friction member and a fastener sleeved on the pivot shaft in that order, the friction member is sandwiched between the elastic member and the fastener, and the elastic member is resisted against the cam follower.

11. A hinge mechanism, comprising:
a first connection member defining two pivotal holes and two rotating shaft holes separately positioned between the two pivotal holes;
two rotation assemblies parallelly assembled to the first connection member, each rotation assembly comprising:
a pivot shaft passing through one corresponding pivotal hole of the first connection member; and
a main gear non-rotatably sleeved on the pivot shaft, the main gear being a bevel gear;
a transmission assembly assembled between the two rotation assemblies for rotatably assembling the two rotation assemblies together, and transmitting a rotating torque between the two rotation assemblies; the transmission assembly comprising:
two rotating shafts fixed to the two rotating shaft holes and parallelly positioned between the two pivot shafts;
two transmission gears respectively sleeved on the two rotating shafts, and positioned between the two main gears of the two rotation assemblies, the two transmission gears being bevel gears engaging with each other and each transmission gear engaging with one of the two main gears; and
two resilient members sleeved on the two rotating shafts, respectively, and each resilient member elastically resisting on a larger end of one corresponding transmission gear axially; and
a second connection member sleeved on the two pivot shafts and the two rotating shafts, thereby holding the two main gears and the two transmission gears between the first and second connection members.

12. The hinge mechanism of claim 11, wherein the main gear and the transmission gear are both spur bevel gears or skew bevel gears.

13. The hinge mechanism of claim 11, wherein the transmission gear has a thickness less than that of the corresponding main gear.

14. The hinge mechanism of claim 13, wherein the transmission gear has a thickness to be half of the thickness of the corresponding main gear.

15. The hinge mechanism of claim 11, wherein the hinge mechanism further comprises a reinforcing member sleeved on the two pivot shafts and resisted against the second connection member.

16. The hinge mechanism of claim 15, the rotation assembly further comprises two cams and two cam followers, the two cams are respectively rotatably sleeved on the pivot shaft and resisted against the reinforcing member; the two cam followers are non-rotatably sleeved on the two pivot shafts and each cam follower is engaged with one corresponding cam.

17. The hinge mechanism of claim 16, wherein the reinforcing member defines two limit holes; the cam comprises a main body and a latching portion formed on the main body, the main body defines a shaft hole, the main body is sleeved on one pivot shaft via the shaft hole; the latching portion of each cam latches into one limit hole of the reinforcing member.

18. The hinge mechanism of claim 17, wherein the cam further comprises two protrusions formed on one end surface of the main body thereof away from the latching portion side; the cam follower rotatably engages with the cam, and defines two cutouts engaging with the corresponding two protrusions of the cam.

19. The hinge mechanism of claim 16, wherein the rotation assembly further comprises two fastening modules respectively fixed to the two pivot shafts and resisting against the two corresponding cam followers.

20. The hinge mechanism of claim 19, wherein each fastening module comprises an elastic member, a friction member and a fastener sleeved on the pivot shaft in order, the friction member is sandwiched between the elastic member and the fastener, and the elastic member is resisted against the cam follower.
